(19) United States
(12) Patent Application Publication
(10) Pub. No.: US 2025/0198086 A1
(43) Pub. Date: Jun. 19, 2025

(54) Biocide control in paper making

(71) Applicant: Kemira Oyj, Helsinki (FI)

(72) Inventors: Jaakko EKMAN, Helsinki (FI); Marko KOLARI, Helsinki (FI); Anu JAAKKOLA, Helsinki (FI)

(21) Appl. No.: 18/875,193

(22) PCT Filed: Jul. 7, 2023
(86) PCT No.: PCT/FI2023/050434

§ 371 Date: Dec. 16, 2024

(30) Foreign Application Priority Data
Jul. 14, 2022 (FI) 20225664

(51) Int. Cl. D21G 9/00; D21D 5/28; D21H 21/04; D21H 21/36; D21H 23/78

(52) U.S. Cl. CPC D21G 9/0018; D21D 5/28; D21H 21/04; D21H 21/36; D21H 23/78

(57) ABSTRACT

A method for controlling paper making includes monitoring (302) a surface level of a fibrous suspension in a storage, and identifying (303) that the surface level has decreased so that at least one emptying criterion is met and thereafter identifying that the surface level has increased so that at least one refilling criterion is met, and responsively to the identifying that the surface level has increased so that the at least one refilling criterion is met, starting to dose a biocide agent into the fibrous suspension entering the storage. A corresponding apparatus and computer program are disclosed.

### TECHNICAL FIELD

The present disclosure generally relates to biocide control in paper making. The disclosure relates particularly, though not exclusively, to biocide control in paper making using recycled fibres.

### BACKGROUND

This section illustrates useful background information without admission of any technique described herein representative of the state of the art.

Recycled fibre, i.e., secondary fibre, is obtainable as raw material from recycled corrugated containers, for example. Such recycled fibre material often contains a lot of starch as it is a common strength additive. The starch together with various impurities, e.g., from food-package recycling, can induce extensive microbial growth. Linerboard and fluting are components of corrugated containerboard. It is common that manufacturing processes using recycled fibres for making of the linerboard or fluting suffer from microbiological problems, such as inadvertent generation of volatile fatty acids. This easily results in a bad smell in production environment and final board. At the same time, typically pH drops, and conductivity increases. In conjunction, these effects of microbiological activity may cause more unstable wet-end and runnability problems, or even some explosive gas emission. These problems may accelerate in large storage towers for process water, fibre suspension and broke, which tend to have long retention times. The storage tower for recycled fibre suspension is particularly exposed to these problems. The volume of such a tower is typically significant, such as vary from hundreds of cubic metres to several thousands of cubic meters. A nominal pulp retention time in such towers may be only a few hours. However, consistency of the fibrous suspension in these towers may be rather high, such as 3 to 12% or even up to 20%. Bottom mixers may be provided to circulate the contents of the tower. However, an influence of the bottom mixer may only reach a very bottom of the tower volume, such as a tenth or fifth of the tower volume.

These storage towers are typically filled from top. In some cases, additional fibre suspension is pumped with a strong pump via a pipeline to the top of tower, which may be meters or even up to 30 meters higher than the bottom of the storage tower. At the top of the storage tower, this flow of additional fibre suspension is shooting downwards with a significant force. This may cause a channelling effect, i.e., at the surface level of the tower, at the point of impact the incoming fibre suspension may travel downwards much faster than the fibre suspension at the edges of the same tower. It is deduced that these towers, independent of total volume, may contain zones of pulp which move only very slow, in contrary to the main flow that channels through the tower. It is now understood that such slow-moving zones may contain material that has been retained for several days. Such material may therefore host a particular microbiological habitat. In such zones the anaerobic bacteria have great habitat to multiply, and fermentation activity can get extremely high. Moreover, content of anaerobic, cellulose-degrading bacteria, may increase. The larger and the more active these slow-moving zones grow, the more they impact the channelled main flow through the tower, as a part of these materials gets mixed to the main flow, while an anaerobic core of the slow-moving zone continues fermentation and spoilage of fibre suspension.

Adverse effects resulting from the microbiological growth may be manifested to papermaking when the tower surface level visits a low level and pulp starts to flow out from these slow-moving zones, bringing large volumes of spoiled raw material forward in the papermaking process

Unfortunately, when these slow-moving zones have been once formed, their microbiological habitat is hardly changeable by addition of a biocide to a storage tower inlet or directly to the storage tower. It appears that once the slow-moving zones have been formed, the biocide simply cannot reach these zones anymore and impact remains in the main flow, with a risk that the main flow becomes overly chemicalised.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

In this document, paper making may refer to making paper, liner, fluting, tissue, or board.

According to a first example aspect there is provided a method for controlling paper making, comprising
monitoring a surface level of a fibrous suspension in a storage; and
identifying that the surface level has decreased so that at least one emptying criterion is met and thereafter identifying that the surface level has increased so that at least one refilling criterion is met; and
responsively to the identifying that the surface level has increased so that the at least one refilling criterion met, starting to dose a biocide agent into the fibrous suspension entering the storage.

The at least one emptying criterion refers to a partial emptying of the storage. The at least one emptying criterion may be defined such that when met, the storage still contains at least a minimum amount of the fibrous suspension. The minimum amount may be at least 15; 20; 30; or 40 percent of a capacity of the storage. Advantageously, the minimum amount is large enough so that the biocide dosing is performed when the surface level has not decreased quite close to a bottom of the storage. On the other hand, it may risk unnecessary dosing if the at least one emptying criterion can be triggered at high surface levels wherein the slow-moving zones would not be effectively reached by booster biocide dosing. Therefore, 30%, 35%, and 40% are seen as particularly well-suited numbers for the minimum amounts.

The storage capacity may be at least 200 m³, more preferably at least 500 m³, or even more preferably at least 800 m³.

The at least one emptying criterion may comprise that the surface level has decreased to a given lower threshold, such as to the minimum amount. The lower threshold may be defined as a given height. Alternatively, the lower threshold may be dynamically defined as a decrement of the surface level, such as corresponding preferably to at least 10%, more preferably to at least 20%, or even more preferably to at least 30% of the storage capacity. The at least one emptying criterion may further comprise a decrement period defining a maximum time, such as 1 h or 2 h, during which the decrement must occur.

The lower threshold may be adaptively defined based on previous measurements relating to microbial activity in the storage. The microbial activity in the storage may be measured continuously, periodically, non-periodically, or repeatedly. The microbial activity may be measured when increased microbial activity is suspected. The microbial activity may be measured when increased microbial activity risk is detected. The lower threshold may be adaptively defined based on microbial activity measurements performed during a microbial activity measurement period. The microbial activity measurement period may comprise at least previous 10 minutes, 30 minutes, 1 hour, 6 hours, 12 hours, 24 hours, or 72 hours. The microbial activity measurement period may comprise at most previous 30 minutes, 1 hour, 6 hours, 12 hours, 24 hours, 72 hours, or 1 week. The microbial activity measurement results may be compared with a predetermined baseline indicating a desired and/or an acceptable amount of microbial activity.

The lower threshold may be increased, when high and/or increased microbial activity is detected in the storage. This way the emptying criterion is more easily met and earlier biocide dosing promoted. The lower threshold may be lowered when low and/or decreased microbial activity is detected in the storage. This way the emptying criterion is not met so easily, and unnecessary biocide dosing is more likely avoided.

The at least one refilling criterion refers to a partial refilling of the storage. The at least one refilling criterion may comprise that the surface level has increased to an upper threshold. The upper threshold may be defined as a given height. Alternatively, the upper threshold may be defined as an increment of the surface level starting from a cycle bottom surface level defined as a minimum surface level between meeting the at least one emptying criterion and thereafter meeting the at least one refilling criterion. The increment may correspond to a 0.1 to 5% of the storage capacity.

The at least one emptying criterion may comprise that a given renewal period has lapsed since previous time the surface level in the storage has previously met the at least one emptying criterion. The renewal period may be preferably at least 24, or more preferably at least 36, or even more preferably 48 hours.

The at least one refilling criterion may comprise that the surface level has increased with a given rate during an increment period. The given rate of surface level increase during the increment period may correspond to at least 20% to at least 50% of a storage capacity per one hour. The increment period may be at least 30, 60, 180, or 300 seconds. Advantageously, a period of at least 30 seconds may provide a rapid indication of started filling if the rate over that period is sufficiently significant. The increment period of at least 60 seconds may better account for measurement fluctuation and while still being relatively fast. The increment period of 180 seconds further reduces a risk of prematurely early starting of the dosing of the biocide agent. With the increment period of 300 seconds, the premature starting is still more unlikely. While a layer of some height might be formed during that period, it is still likely that if the increase is of any significance, then the following inflow also comes with such a rate that the inflow may cause such a turbulence that mixes the incoming biocide agent to underlying fibrous suspension. Hence, the dosing may be extended sufficiently deep into the slow-moving zones or pockets in the storage.

The dosing of the biocide agent may be terminated when the surface level meets a given termination level threshold. The termination level threshold may correspond to at least 80% or 90% of the storage capacity, or such as at most 1 or 5% of storage capacity below a refilling target to which the storage is being refilled.

The dosing of the biocide agent may be terminated when the surface level increase meets a given terminating increment threshold, such as corresponding to at least 20 or 40 percentage points of a storage capacity of the storage.

The dosing of the biocide agent may be continued for a continuation period. The continuation period may be at least 2 hours; 3 hours; or 5 hours. The continuation period may be at most 3 hours; 4 hours; or 10 hours.

The dosing may be performed proportionally to input fibrous suspension that is entering the storage. The dosing may be targeted to a range between 5 mg/l and 300 mg/l The dosing may be between 10 mg/l and 50 mg/l for bronopol; CMIT; or MIT. The dosing may be between 50 mg/l and 200 mg/l for glutaraldehyde.

The dosing may be directed to addition of the fibrous suspension entering the storage in the storage. The dosing may be directed onto the fibrous suspension entering in a feed line. Alternatively, or partially additionally, the dosing may be directed onto the fibrous suspension entering the storage after entry into the storage.

The dosing may be directed to the fibrous suspension in the storage.

The fibrous suspension may be input to the storage through a first end of the storage. The fibrous suspension may be output from the storage through a second end of the storage that may be opposite to the first end of the storage.

The storage may be a storage tower. The storage may have a calculated residence time greater than two hours.

A residence time of the fibrous suspension in the storage may be monitored. A first signal may be output if the residence time meets a first time threshold, such as 4 days; 5 days; 6 days; 7 days; 8 days; or 9 days. The first signal may indicate a cause of signal, such as aging event. The first signal may be output to a user interface. The first signal may be output to a process control loop for mitigating measures. The mitigating measures may comprise at least partially emptying the storage. A second signal may be output if the residence time meets a second time threshold, such as 48 hours, if a pH or an rH has changed meeting a pH or rH change threshold, respectively. The second signal may indicate a cause of signal, such as an intermediate deterioration risk event. The second signal may be output to a user interface. The second signal may be output to a process control loop for mitigating measures. The mitigating measures may comprise at least partially emptying the storage.

The storage may be cylindrical, optionally having a height that is at least 1; 2; 5; or 10 times a diameter of the storage.

The fibrous suspension may comprise cellulose and hemicellulose in a water suspension in which a dry matter content is at most 1; 2; 10; or 20 weight percent.

The fibrous suspension may comprise cellulose and hemicellulose in a water suspension in which a dry matter content is at least 0.5; 1; 2; 10; or 15 weight percent.

The method may comprise quantifying anaerobic bacteria in the storage. The quantifying may be performed continuously. The quantifying may be performed periodically, e.g., once a week or once a month. The quantifying may be performed non-periodically, e.g., between 1 to 100 days. The quantifying may be performed repeatedly. The quantifying may be performed using one or more laboratory tests. The quantifying may comprise using a DNA detection method. The quantifying may comprise detecting a total amount of bacteria. The quantifying may comprise detecting a relative amount or number of given bacteria.

The method may further comprise adjusting the dosing according to the quantifying of the anaerobic bacteria in the storage. The method may further comprise adjusting the dosing according to a dosing schedule. The method may further comprise adjusting the dosing according to a current surface level. The method may further comprise adjusting the dosing according to a current fill rate with which the storage is being filled.

The adjusting may comprise increasing or decreasing dosing of the biocide agent. The dosing may be adjusted by modifying composition and/or concentration of the biocide agent. The biocide agent may be produced by mixing two or more biocide constituents. The biocide constituents may be separately suited for biocide use.

The biocide agent may comprise a non-oxidising biocide. The biocide agent may comprise an oxidising biocide. The biocide agent may comprise a non-oxidising biocide and a non-oxidising biocide.

The oxidising biocide may be selected from a group consisting of: monochloramines, MCA; sodium hypochlorite; active chlorine generated from sodium chloride by electrolysis; chlorine dioxide or a stabilised-chlorine compound; wherein the stabilised-chlorine compound comprises the reaction product of a reaction between active chlorine and a nitrogenous reactant that is selected from: ammonium salt; urea; ammonium carbamate or dimethylhydantoin; performic acid; preferably monochloramines; ammonium salts reacted with hypochlorite; urea reacted with hypochlorite; dimethylhydantoin reacted with hypochlorite; performic acid; monohalodimethylhydantoins; dihalodimethylhydantoins; and any combination of those.

The non-oxidising biocide may be selected from a group consisting of: glutaraldehyde; bronopol; 2,2-dibromo-3-nitrilopropionamide, DBNPA; 5-chloro-2-methyl-4-isothiazolin-3-one, CMIT; 2-methyl-4-isothiazolin-3-one, MIT; 2-n-octyl-4-isothiazolin-3-one, OIT; 4,5-dichloro-2-(n-octyl)-4-isothiazolin-3-one, DCOIT; 1,2-benzisothiazolin-3-one BIT; 2-(thiocyanomethylthio) benzothiazole, TCMTB; methylene dithiocyanate, MBT; tetrakis(hydroxymethyl)phosphonium sulphate, THPS; sodium dimethyldithiocarbamate; didecyldimethylammoniumchloride, DDAC; alkyldimethylbenzylammonium chloride, ADBAC, preferably glutaraldehyde; bronopol; 5-chloro-2-methyl-4-isothiazolin-3-one, CMIT; 2-methyl-4-isothiazolin-3-one MIT; and any combination of those.

The method may comprise dosing the biocide agent for mitigating slow-moving zone issues, in response to the meeting of the at least one emptying and the at least one refilling criterion. The method may comprise additionally dosing the same or another biocide, such as an oxidising biocide, a non-oxidising biocide, or both oxidising and non-oxidising biocides, to decrease overall microbial activity either as a continuous dosing or as frequent shocks. In such a case, the method comprises a first biocide treatment, and a second biocide treatment that is performed in response to identifying that the surface level of the fibrous suspension in the storage has met the at least one emptying criterion and the at least one refilling criterion. The first biocide treatment may be performed repeatedly, continuously, periodically, and/or non-periodically. The first biocide treatment may be emphasised when performing the second biocide treatment for increased impact on forming the slow-moving zones. When the method comprises the additional dosing of the same or another biocide in response to identifying the meeting of the at least one emptying criterion and the at least one refilling criterion, the starting of the dosing may refer to starting of dosing that is conditional on these criteria. Moreover, when the method comprises the additional dosing of the same or another biocide in response to identifying the meeting of the at least one emptying criterion and the at least one refilling criterion, the stopping of the dosing may refer to stopping of the dosing that is conditional on these criteria.

The first biocide treatment may be performed using a non-oxidising biocide, and the second biocide treatment may be performed using a non-oxidising biocide. The first biocide treatment may be performed using an oxidising biocide, and the second biocide treatment may be performed using a non-oxidising biocide. The first biocide treatment may be performed using an oxidising and non-oxidising biocide, and the second biocide treatment may be performed using a non-oxidising biocide. The first biocide treatment may be performed using an oxidising and a non-oxidising biocide, and the second biocide treatment may be performed using an oxidising and a non-oxidising biocide. The first biocide treatment may be performed using a non-oxidising biocide, and the second biocide treatment may be performed using an oxidising biocide. The first biocide treatment may be performed using an oxidising biocide, and the second biocide treatment may be performed using an oxidising biocide. The first biocide treatment may be performed using an oxidising and non-oxidising biocide, and the second biocide treatment may be performed using an oxidising biocide.

In the first biocide treatment with a biocide, the oxidising biocide may be selected from active chlorine released from sodium hypochlorite; active chlorine generated from sodium chloride by electrolysis; chlorine dioxide or a stabilised-chlorine compound; wherein the stabilised-chlorine compound comprises the reaction product of a reaction between active chlorine and a nitrogenous reactant selected from: ammonium salt; urea; ammonium carbamate or dimethylhydantoin. A preferred first biocide is monochloramine (MCA), a reaction product of a reaction between active chlorine and an ammonium salt.

It is realised by the inventors that there is only a relatively brief window of time when the slow-moving zones can be adequately impacted by the biocide. This is when these slow-moving zones are formed. At this time, the storage starts to fill up and the pressure of the bulk in the storage starts to impact flowing of the stored pulp potentially creating separate slow-moving zones and channel flows. The inlet flow should be treated at this time, with a biocide chemistry suited to impact the slow-moving zones while they are forming. When so dosed, biocide concentration should remain adequate in these slow-moving zones to inhibit microbial activity until the procedure of surface lowering, and refilling with biocide, is repeated. Further advantageously, by boosting the dosing during the window of time when these slow-moving zones are formed, excess consumption of the biocide may be avoided.

By lowering the storage tower surface, treating the slow-moving zones with a booster biocide dose while refilling the storage, and repeating this procedure before the control of slow-moving zones is lost, a more stable papermaking process may be achieved.

Further advantageously, by performing such booster treatment on meeting the at least one emptying criterion and then the at least one refilling criterion, the booster treatment may be performed on-demand whenever a suitable occasion arrives.

According to a second example aspect there is provided an apparatus for controlling pulp or paper making, comprising
at least one processor and memory comprising program code, collectively configured to:
   monitor a surface level of a fibrous suspension in the storage;
   identify that the surface level has decreased so that at least one emptying criterion is met and thereafter the surface level has increased so that at least one refilling criterion is met; and
   responsively to the identifying that the surface level has increased so that the at least one refilling criterion is met, cause starting to dose of a biocide agent into the fibrous suspension entering the storage.

According to a third example aspect there is provided a computer program comprising computer executable program code which when executed by at least one processor causes an apparatus at least to perform, for controlling paper making,
monitoring a surface level of a fibrous suspension in the storage; and
identifying that the surface level has decreased so that at least one emptying criterion is met and thereafter identifying that the surface level has increased so that at least one refilling criterion is met; and
responsively to the identifying that the surface level has increased so that the at least one refilling criterion is met, starting to dose a biocide agent into the fibrous suspension entering the storage.

According to a fourth example aspect there is provided a computer program product comprising a non-transitory computer readable medium having the computer program of the third example aspect stored thereon.

According to a fifth example aspect there is provided an apparatus comprising means for performing the method of any preceding aspect.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilised in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment, in four different filling states a) to d) of a of fibrous suspension;

FIG. 2 shows a block diagram of an apparatus according to an example embodiment; and

FIGS. 3a to 3d show a flow chart according to an example embodiment.

### DETAILED DESCRIPTION

In the following description, like reference signs denote like elements or steps.

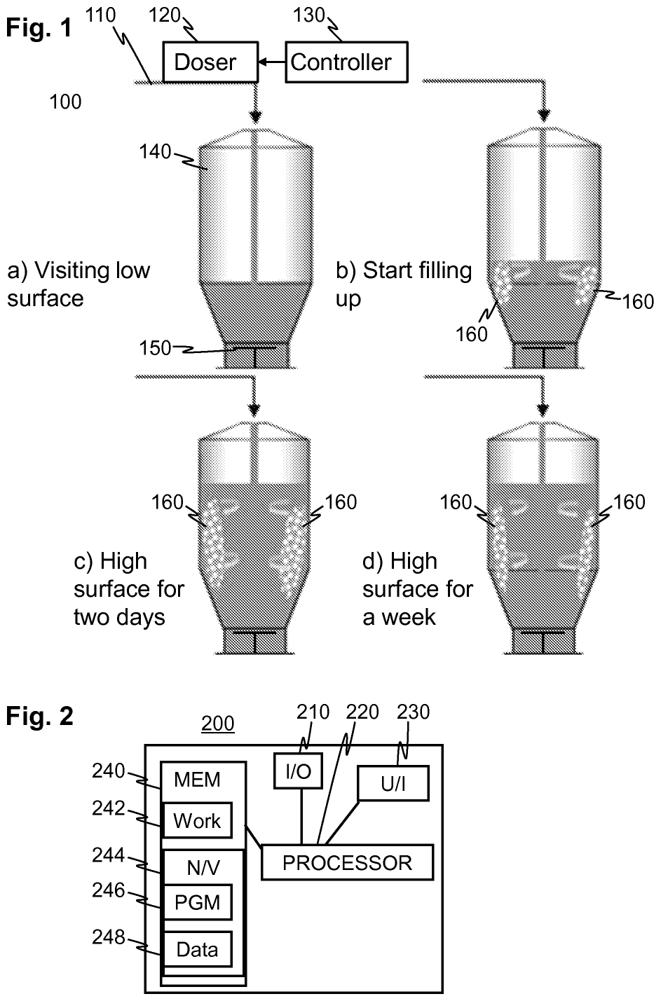

FIG. 1 schematically shows a system 100 according to an example embodiment, in four different filling states a) to d) of a of fibrous suspension. The system comprises an inlet line 110, a doser 120 for dosing a biocide agent into the inlet line to incoming fibrous suspension, a controller 130 for controlling the doser 120, a storage tower 140, and a bottom mixer 150 for mixing the fibrous suspension in the storage tower 140. In an example embodiment, the system 100 further comprises a pre-dosing device (not shown) to administer a basic dosing of biocide independent of the operation of the doser 120 that may perform temporally focused dosing for mitigating problems with slow-moving zones 160.

Slow-moving zones start to form when storage tower fills up with additional fibre suspension and the pressure of the bulk in the storage starts to impact flows in the stored pulp. In time slow-moving zone generates a habitat with highly active anaerobic microorganisms, different from the channelling main flow through the tower.

FIG. 2 shows a block diagram of an apparatus 200 according to an example embodiment. The apparatus 200 comprises a communication interface 210; a processor 220; a user interface 230; and a memory 240.

The communication interface 210 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the apparatus 200 or provided as a part of an adapter, card, or the like, that is attachable to the apparatus 200. The communication interface 210 may support one or more different communication technologies. The apparatus 200 may also or alternatively comprise more than one of the communication interfaces 210.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the apparatus 200, e.g., via a keyboard; graphical user interface shown on the display of the apparatus 200; speech recognition circuitry; or an accessory device; such as a headset; and for providing output to the user via, e.g., a graphical user interface or a loudspeaker.

The memory 240 comprises a work memory 242 and a persistent memory 244 configured to store computer program code 246 and data 248. The memory 240 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The apparatus 200 may comprise a plurality of the memories 240. The memory 240 may be constructed as a part of the apparatus 200 or as an attachment to be inserted into a slot; port; or the like of the apparatus 200 by a user or by another person or by a robot. The memory 240 may serve the sole purpose of storing data, or be constructed as a part of an apparatus 200 serving other purposes, such as processing data.

A skilled person appreciates that in addition to the elements shown in FIG. 2, the apparatus 200 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the apparatus 200 may comprise a disposable or rechargeable battery (not shown) for powering the apparatus 200 if external power supply is not available.

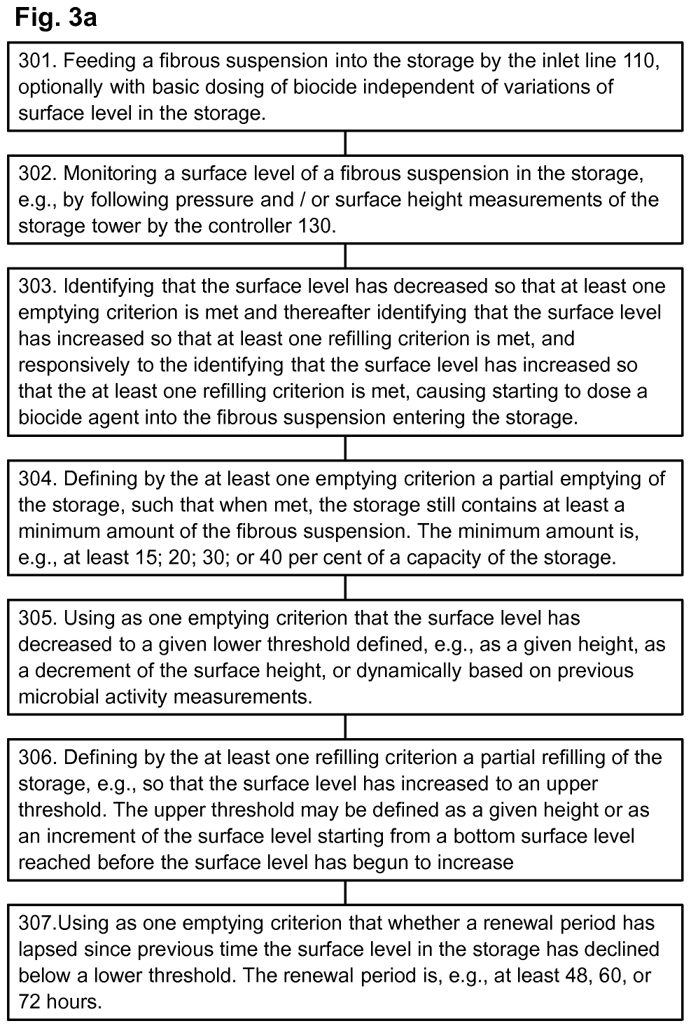

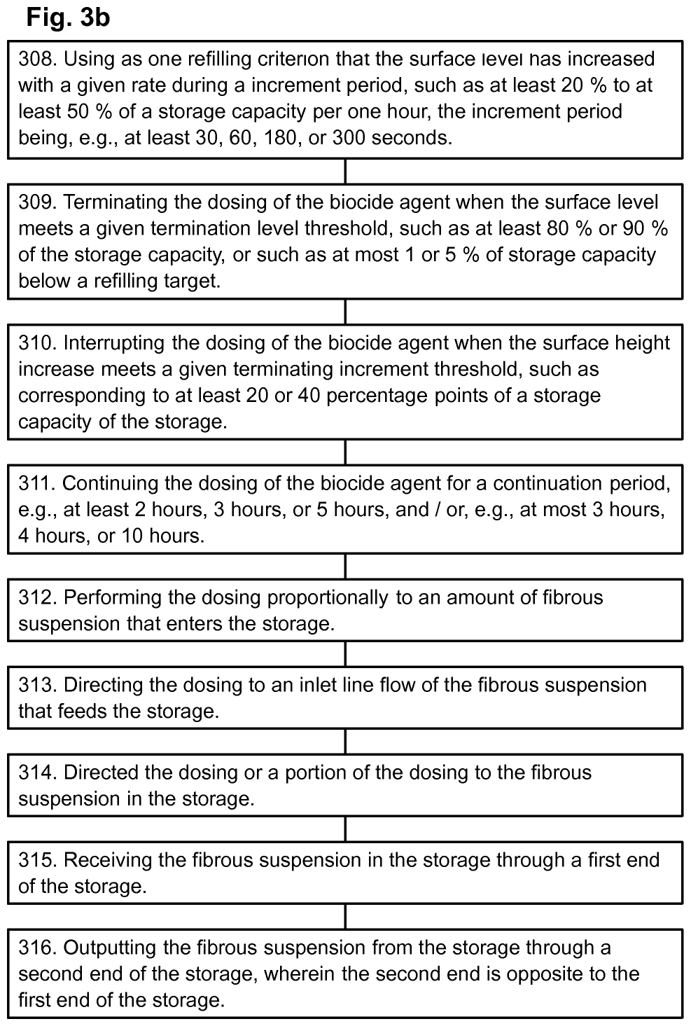

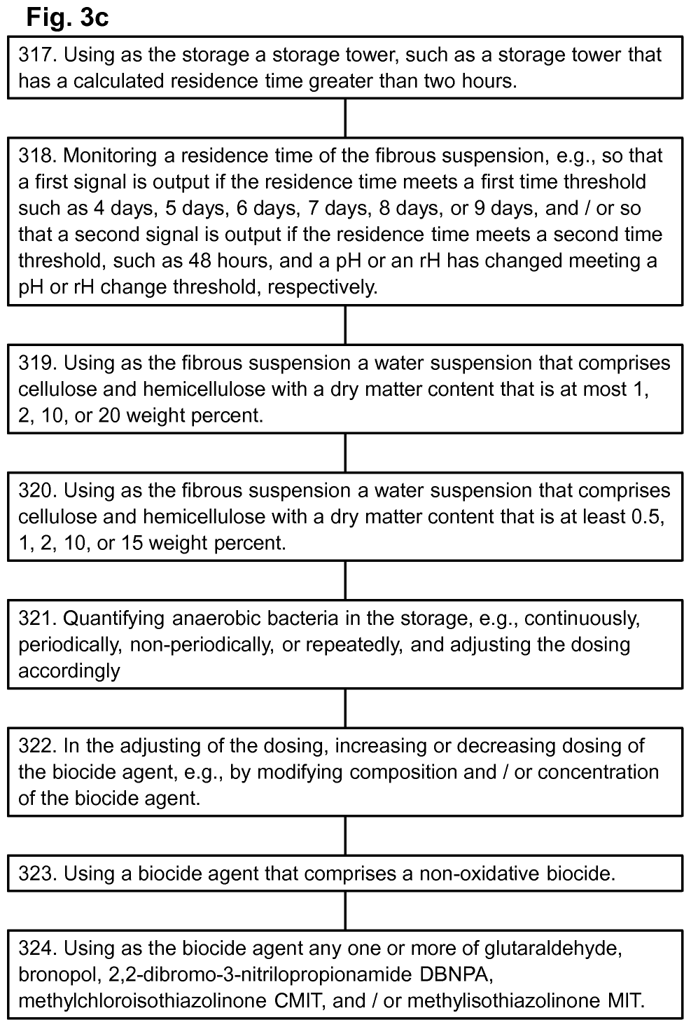

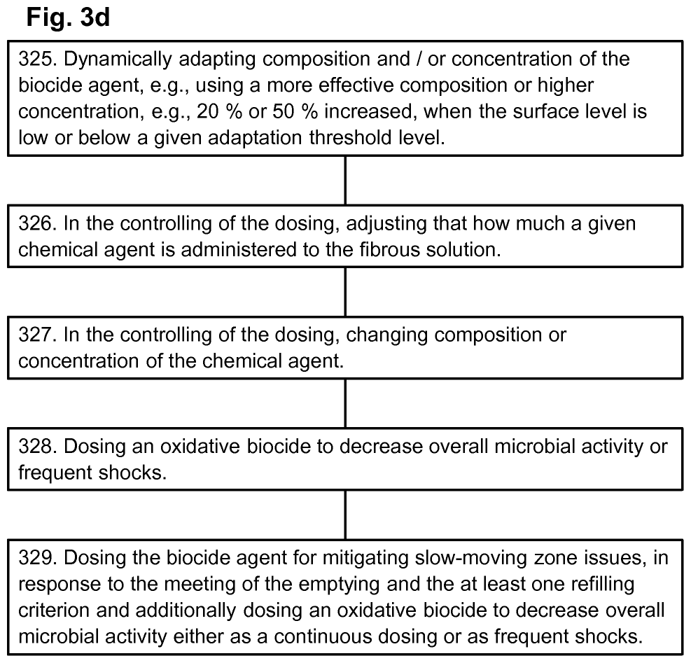

Various example embodiments are next described with reference to FIGS. 3a to 3d that show a flow chart according to an example embodiment. FIGS. 3a to 3d illustrate a process comprising various possible steps including some optional steps while also further steps can be included and/or some of the steps can be performed more than once:

301. Feeding a fibrous suspension into the storage by the inlet line 110, optionally with a basic dosing of biocide independent of variations of surface level in the storage.

302. Monitoring a surface level of a fibrous suspension in the storage, e.g., by following pressure and/or surface height measurements of the storage tower by the controller 130.

303. Identifying that the surface level has decreased so that at least one emptying criterion is met and thereafter identifying that the surface level has increased so that at least one refilling criterion is met, and responsively to the identifying that the surface level has increased so that the at least one refilling criterion is met, causing starting to dose a biocide agent into the fibrous suspension entering the storage. The dosing can be performed before entry of the fibrous suspension, on entry, or after entry of the fibrous suspension into the storage, into the fibrous suspension entering the storage. In an example embodiment, the starting to dose of the biocide agent commences an adaptive or conditional dosing in addition to an ongoing dosing of the same or other biocide agent that may be continuous, periodic, or non-periodic.

304. Defining by the at least one emptying criterion a partial emptying of the storage, such that when met, the storage still contains at least a minimum amount of the fibrous suspension. The minimum amount is, e.g., at least 15; 20; 30; or 40 percent of a capacity of the storage.

305. Using as one emptying criterion that the surface level has decreased to a given lower threshold defined, e.g., as a given height, as a decrement of the surface level, or dynamically based on previous microbial activity measurements.

306. Defining by the at least one refilling criterion a partial refilling of the storage, e.g., so that the surface level has increased to an upper threshold. The upper threshold may be defined as a given height or as an increment of the surface level starting from a bottom surface level reached before the surface level has begun to increase.

307. Using as one emptying criterion that whether a renewal period has lapsed since previous time the surface level in the storage has declined below a lower threshold. The renewal period is, e.g., at least 48; 60; or 72 hours.

308. Using as one refilling criterion that the surface level has increased with a given rate during an increment period, such as at least 20% to at least 50% of a storage capacity per one hour, the increment period being, e.g., at least 30; 60; 180; or 300 seconds.

309. Terminating the dosing of the biocide agent when the surface level meets a given termination level threshold, such as at least 80% or 90% of the storage capacity, or such as at most 1 or 5% of storage capacity below a refilling target.

310. Terminating the dosing of the biocide agent when the surface level increase meets a given terminating increment threshold, such as corresponding to at least 20 or 40 percentage points of a storage capacity of the storage.

311. Continuing the dosing of the biocide agent for a continuation period, e.g., at least 2 hours; 3 hours; or 5 hours; and/or, e.g., at most 3 hours; 4 hours; or 10 hours.

312. Performing the dosing proportionally to an amount of fibrous suspension that enters the storage, e.g., as some tens or hundreds of mg/l to the fibrous suspension.

313. Directing the dosing to an inlet line flow of the fibrous suspension that feeds the storage.

314. Directed the dosing or a portion of the dosing to the fibrous suspension in the storage.

315. Receiving the fibrous suspension in the storage through a first end of the storage.

316. Outputting the fibrous suspension from the storage through a second end of the storage, wherein the second end is opposite to the first end of the storage.

317. Using as the storage a storage tower, such as a storage tower that has a calculated residence time greater than two hours.

318. Monitoring a residence time of the fibrous suspension, e.g., so that a first signal is output if the residence time meets a first time threshold such as 4 days; 5 days; 6 days; 7 days; 8 days; or 9 days; and/or so that a second signal is output if the residence time meets a second time threshold, such as 48 hours, and a pH or an rH has changed meeting a pH or rH change threshold, respectively.

319. Using as the fibrous suspension a water suspension that comprises cellulose and hemicellulose with a dry matter content that is at most 1; 2; 10; or 20 weight percent.

320. Using as the fibrous suspension a water suspension that comprises cellulose and hemicellulose with a dry matter content that is at least 0.5; 1; 2; 10; or 15 weight percent. 321. Quantifying anaerobic bacteria in the storage, e.g., continuously; periodically; non-periodically; or repeatedly, and adjusting the dosing accordingly.

322. In the adjusting of the dosing, increasing or decreasing dosing of the biocide agent, e.g., by modifying composition and/or concentration of the biocide agent. 323. Using a biocide agent that comprises a non-oxidising biocide.

324. Using as the biocide agent any one or more of glutaraldehyde; bronopol; 2,2-dibromo-3-nitrilopropionamide DBNPA; methylchloroisothiazolinone CMIT; and/or methyliso-thiazolinone MIT.

325. Dynamically adapting composition and/or concentration of the biocide agent, e.g., using a more effective composition or higher concentration, e.g., 20% or 50% increased, when the surface level is low or below a given adaptation threshold level.

326. In the controlling of the dosing, adjusting that how much a given chemical agent is administered to the fibrous solution.

327. In the controlling of the dosing, changing composition or concentration of the chemical agent.

328. Dosing an oxidising biocide to decrease overall microbial activity or frequent shocks.

329. Dosing the biocide agent for mitigating slow-moving zone issues, in response to the meeting of the at least one emptying and the at least one refilling criterion and additionally dosing an oxidising biocide to decrease overall microbial activity either as a continuous dosing or as frequent shocks.

As would be understood by the skilled person, rH corresponds to a pH- and temperature-adjusted oxidation-reduction potential (ORP). In one example, rH may be calculated using the following equation:

$$rH = 2 \cdot pH + 2 \cdot Eh \cdot F / ( 2.3026 \cdot R \cdot T ) ,$$

Eh is oxidation reduction potential measured using a standard hydrogen electrode (V)
F is Faraday constant (96485 C·mol⁻¹)
R is Gas constant 8.314 J·K-1·mol⁻¹
T is temperature in Kelvins (K).

Testing was conducted to verify the efficacy of 9 different biocide agents against microbial communities in RCF processes from four different mills. Bronopol-containing biocide Product A (Active ingredients DBNPA; Bronopol; CMIT; and MIT), Product B (Active ingredients Bronopol; CMIT; and MIT) and Product C (Bronopol) were the most efficient preservatives. They could prevent the growth of anaerobic bacteria and pH drop for several days. When Product A and Product B were used together with an oxidiser (monochloramine, MCA), the bacterial growth was prevented for at least 7 days with a 10 mg/l to 30 mg/l dose. This indicates that it is possible to preserve recycled fibre pulp also in mill conditions for several days. It is assumed based on the results that mixing in the recycling fibre pulp towers is insufficient to prevent formation of slow-moving zones of old pulp. Based on the experimentation, it appears to suffice to cause the fibrous suspension in the tower visit low surface level once a week, when a biocide booster dose (extra biocide dosing batch on top of the base biocide treatment) is applied in the correct time window where refilling of the tower has begun and an impact to slow-moving zones is possible. For example, the base biocide treatment may comprise regular treatment (continuous dosing or several daily batches) with an oxidising biocide, such as MCA, and the booster dose may occur automatically, at a correct time to reach the slow-moving zones. This may happen only 5 to 10 times per month.

In further comparative testing, it was found out that the dosing according to an example embodiment produced an improved quality in recycled board while reducing total consumption of biocide. Average bacterial content in dry board was 3.31 times lowered and the median number of bacterial content was 1.18 times lowered. These numbers originate from a comparison of 40 analyses of final board, in total representing a time period of 40 subsequent days with dosing according to an example embodiment, compared to 40 analyses from a similar time period with an old dosing strategy, just prior to switching to use the dosing according to this example embodiment. Sum consumption of biocide product during period with innovation in use was still 3% lower than in the comparison period, demonstrating that the bacterial control was improved through temporally focused dosing instead of an increase in biocide use. In this experiment, bacterial content in the dry board was quantified according to ISO standard 8784-1:2014 Pulp, paper and board-Microbiological examination. Part 1: Enumeration of bacteria and bacterial spores based on disintegration.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method for controlling paper making, comprising
monitoring a surface level of a fibrous suspension in a storage, and
identifying that the surface level has decreased so that at least one emptying criterion is met and thereafter identifying that the surface level has increased so that at least one refilling criterion is met, and
responsively to the identifying that the surface level has increased so that the at least one refilling criterion is met, starting to dose a biocide agent into the fibrous suspension entering the storage.

2. The method of claim 1, wherein the at least one emptying criterion comprises that the surface level has decreased to a lower threshold of storage capacity of the storage.

3. The method of claim 2, wherein the lower threshold is dynamically defined as a decrement of the surface level of the storage capacity.

4. The method of claim 2, wherein the lower threshold is adaptively defined based on previous measurements relating to microbial activity in the storage.

5. The method of claim 4, wherein the previous measurements relating to microbial activity are based on one or more effects of degradation of the stored fibrous suspension, such as decreased pH and/or increased electrical conductivity.

6. The method of claim 1, wherein
the at least one refilling criterion comprises that the surface level has increased by a given increment from a cycle bottom surface level;
the cycle bottom surface level is a minimum surface level after meeting the at least one emptying criterion; and
the given increment corresponds to 0.1 to 5% of a storage capacity of the storage.

7. The method of claim 6, wherein the at least one refilling criterion comprises that the surface level has increased with a given rate during an increment period.

8. The method of claim 1, wherein the fibrous suspension comprises recycled fibres.

9. The method of claim 1, further comprising terminating the dosing of the biocide agent when the surface level meets a given terminating height threshold.

10. The method of claim 1, further comprising terminating the dosing of the biocide agent when the surface level increase meets a given terminating increment threshold.

11. The method of claim 1, wherein the dosing is proportional to an amount of the fibrous suspension entering the storage.

12. The method of claim 1, further comprising quantifying anaerobic bacteria and adjusting the dosing accordingly.

13. The method of claim 1, wherein the biocide agent is selected from a group consisting of: an oxidising biocide comprising monochloramines, MCA; sodium hypochlorite; active chlorine generated from sodium chloride by electrolysis; chlorine dioxide or a stabilised-chlorine compound; wherein the stabilised-chlorine compound comprises the reaction product of a reaction between active chlorine and a nitrogenous reactant selected from: ammonium salt; urea; ammonium carbamate or dimethylhydantoin; performic acid; preferably monochloroamines, MCA; ammonium salts reacted with hypochlorite; urea reacted with hypochlorite; dimethylhydantoin; performic acid and any combination of those; and a non-oxidising biocide comprising glutaraldehyde; bronopol; 2,2-dibromo-3-nitrilopropionamide, DBNPA; 5-chloro-2-methyl-4-isothiazolin-3-one CMIT; 2-methyl-4-isothiazolin-3-one, MIT; 2-n-octyl-4-isothiazolin-3-one, OIT; 4,5-dichloro-2-(n-octyl)-4-isothiazolin-3-one, DCOIT; 1,2-benzisothiazolin-3-one BIT; 2-(thiocyanomethylthio) benzothiazole, TCMTB; methylene dithiocyanate, MBT; tetrakis(hydroxymethyl)phosphonium sulphate, THPS; sodium dimethyldithiocarbamate; didecyldimethylammoniumchloride, DDAC; alkyldimethylbenzylammonium chloride, ADBAC, preferably glutaraldehyde; bronopol; 5-chloro-2-methyl-4-isothiazolin-3-one, CMIT; 2-methyl-4-isothiazolin-3-one, MIT; and any combination of those; and any combination of an oxidising and a non-oxidising biocide.

14. An apparatus comprising means for performing the method of claim 1.

15. A non-transitory computer readable medium having stored there on a computer program comprising computer executable program code configured, when executed, to cause a computer to perform the method of claim 1.

16. The method of claim 2, wherein the lower threshold corresponds to at least 10% of the storage capacity of the storage.

17. The method of claim 2, wherein the lower threshold corresponds to at least 20% of the storage capacity of the storage.

18. The method of claim 2, wherein the lower threshold corresponds to at least 30% of the storage capacity of the storage

19. The method of claim 7, wherein the given rate corresponds to a rate of filling at least 20% to 50% of a storage capacity of the storage per one hour.

20. The method of claim 9, wherein the terminating height threshold is at least 60% of the storage capacity of the storage.
